(19) United States
(12) Patent Application Publication
(10) Pub. No.: US 2012/0323794 A1
(43) Pub. Date: Dec. 20, 2012

(54) MONETIZATION STRATEGIES IN PRIVACY-CONSCIOUS PERSONALIZATION

(75) Inventor: Benjamin Livshits, Kirkland, WA (US)

(73) Assignee: MICROSOFT CORPORATION, Redmond, WA (US)

(21) Appl. No.: 13/160,726

(22) Filed: Jun. 15, 2011

(51) Int. Cl. G06Q 30/00; G06Q 10/00

(52) U.S. Cl. 705/80; 705/7.32

(57) ABSTRACT

Personalization is enabled in a privacy-conscious manner. User interest information can be determined as a function of user behavior with respect interaction with content, for example. Distribution of user information can be managed as function of user permission and one or more offers to acquire the information from parties such as electronic merchants, data aggregators, or ad networks, among others.

### CROSS-REFERENCE TO RELATED APPLICATIONS

This application is related to U.S. application Ser. No. 13/112,244, filed May 20, 2011, and entitled PRIVACY-CONSCIOUS PERSONALIZATION, the entirety of which is incorporated herein by reference.

### BACKGROUND

The World Wide Web (“web”) has transformed from a passive medium to an active medium where users take part in shaping the content they receive. One popular form of active content on the web is personalized content, wherein a provider employs certain characteristics of a particular user, such as their demographic or previous behaviors, to filter, select, or otherwise modify the content ultimately presented. This transition to active content raises serious concerns about privacy, as arbitrary personal/private information may be required to enable personalized content, and a confluence of factors has made it difficult for users to control where this information ends up and how it is utilized.

Because personalized content presents profit opportunity, businesses have incentive to adopt it quickly, oftentimes without user consent. This creates situations that many users perceive as a violation of privacy. A prevalent example of this is already seen with online, targeted advertising, such as AdSense® provided by Google, Inc. By default, this system tracks users who enable browser cookies across all websites that choose to collaborate with the system. Such tracking can be arbitrarily invasive since it pertains to users' behavior at partner sites, and in most cases the users are not explicitly notified that the content they choose to view also actively tracks their actions, and transmits them to a third party. While most services of this type have an opt-out mechanism that any user can invoke, many users are not even aware that a privacy risk exists, much less that they have the option of mitigating the risk.

As a response to concerns about individual privacy on the web, developers and researchers continue to release solutions that return various degrees of privacy to a user. One well-known example is private browsing modes available in most modern web browsers, which attempt to conceal the user's identity across sessions by blocking access to various types of persistent state in the browser. However, web browsers often implement this mode incorrectly, leading to alarming inconsistencies between user expectations and the features offered by the browser. Moreover, even if a private browsing mode were implemented correctly, it inherently poses significant problems for personalized content, as sites are not given access to information needed to perform personalization.

Others have attempted to build schemes that preserve user privacy while maintaining the ability to personalize content. Most examples concern targeted advertising, given its prevalence and well-known privacy implications. For example, both PrivAd and Adnostic are end-to-end systems that preserve privacy by performing all behavior tracking on the client, downloading all potential advertisements from the advertiser's servers, and selecting the appropriate ad to display locally on the client. These systems might suffer from unacceptable latency increases, however, because of the amount of data transfer that needs to take place.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to privacy-conscious personalization and monetization strategies associated therewith. Mechanisms are provided for controlling acquisition and release of private information, for example from within a web browser. Core mining can be performed to infer information, such as user interests, from user behavior. Furthermore, extensions can be employed to supplement the core mining, for instance to extract more detailed information. Moreover, acquisition and dissemination of private information can be controlled as function of user permission. In other words, extensions cannot be added or information released to third parties without the consent of the user to which the information pertains.

Furthermore, a marketplace for user information can established in which users are incentivized to exchange user information with various entities (e.g., electronic merchants, data aggregators, advertisement networks . . . ,) for compensation (e.g., money, discounts, reward program points . . . ). Accordingly, distribution of user information can be managed as a function of one or more offers to acquire the information and user permission. Additionally, various mechanisms can be provided to assist a user, for example in offering information for sale, evaluating offers for information, and consummating a transaction.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system that facilitates interaction between a user and a content provider.

FIG. 2 is a block diagram of an exemplary user agent component.

FIG. 3 is a block diagram of a system that facilitates content personalization in a privacy-conscious manner.

FIG. 4 graphically illustrates a communication protocol for personal information.

FIG. 5 is an exemplary dialog box that prompts a user for permission to disseminate information.

FIG. 6 is a block diagram of a representative user-control component including monitor and recall components.

FIG. 7 is a block diagram of a distributed system within which aspects of the disclosure can be employed.

FIG. 8 is a flow chart diagram of a method of managing distribution of user information.

FIG. 9 is a flow chart diagram of a method of offer acquisition.

FIG. 10 is a flow chart diagram of a method of brokering user information agreements

FIG. 11 is a flow chart diagram of a method of personalization in a privacy-conscious manner.

FIG. 12 is a flow chart diagram of a method of extending system functionality.

FIG. 13 is a flow chart diagram of a method of secure extension operation.

FIG. 14 is a flow chart diagram of method of interacting with a system that facilitates content personalization in a privacy-conscious manner.

FIG. 15 is a schematic block diagram illustrating a suitable operating environment for aspects of the subject disclosure.

### DETAILED DESCRIPTION

Details below are generally directed toward enabling personalized content in privacy-conscious manner. Similar to conventional systems such as PrivAd and Adnostic, sensitive information utilized to perform personalization can be stored close to a user. However, the disclosed subject matter differs both technically and in the notion of privacy considered. Unlike PrivAd and Adnostic, a specific application is not targeted (e.g., advertising). Further, information about a user is not completely hidden from a party responsible for providing personalized content. Rather than completely insulating content providers from user information, a user can decide which remote parties may access various types of locally stored data and manage dissemination in a secure manner. In other words, a user is provided with explicit control over how information is used and distributed to third parties. Additionally, extensions can be employed to provide flexibility to address existing and future personalization applications. Overall, the subject disclosure describes various systems and methods that allow general personalization and privacy to co-exist.

Moreover, a marketplace for user information can be established. Users can be motivated to exchange user information for compensation (e.g., money, discounts, reward program points . . . ) as well as an improved user experience. Content providers, among others, can be similarly motivated to compensate users for their information.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

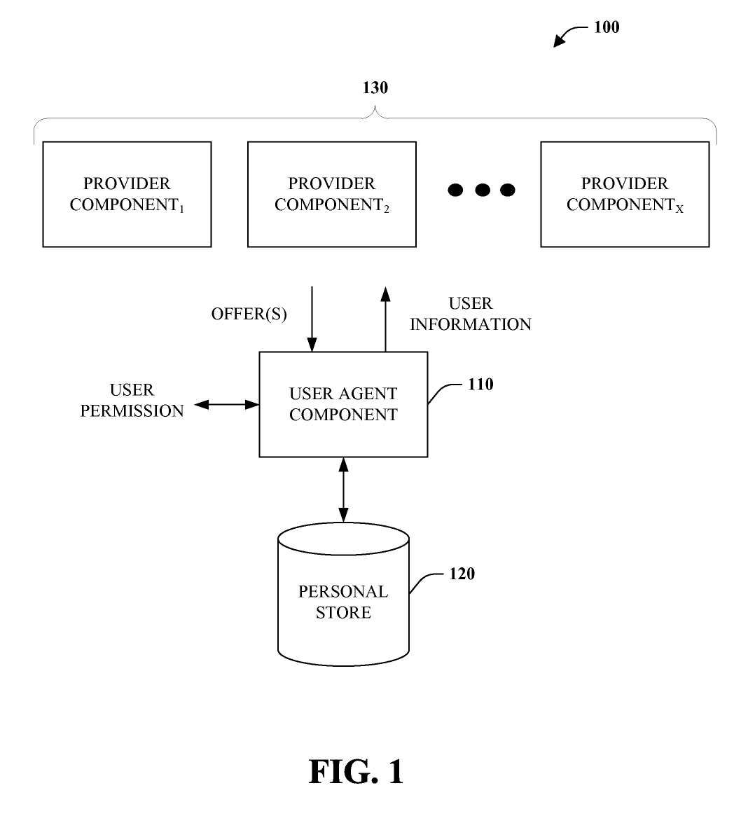

Referring initially to FIG. 1, a system 100 is illustrated that facilitates interaction between a user and content providers. User agent component 110 is communicatively coupled to personal store 120 and one or more content providers 130 (PROVIDER COMPONENT₁−PROVIDER COMPONENT_{X}, where “X” is a positive integer). The personal store 120 houses personal/private user information securely, requiring user permission for release thereof. As will be described further below the user information can correspond to user interest information determined and/or inferred from user behavior such as, but not limited to, navigating to particular websites, among other things. The content provider components 130 are at least associated with, or part of, an entity (e.g., an interface) that that supplies electronic content such as websites, advertisements, among other things, that can be personalized with respect to particular users based on information about them. For example, a website can be formatted to present content that interests a user and advertisements can target users with particular interests. In another instance, the content provider component 130 can correspond to a data aggregator or advertisement network, among others.

The user agent component 110 is configured to mediate or broker interaction with respect to a user information market. Users value privacy but also recognize the benefits of receiving relevant content by way of personalization. Content providers value high-quality user information, since there is a link between the quality of information (e.g., accuracy, granularity . . . ) and sales (e.g., conversion rate). Further, content providers are willing to compensate providers of such information. Still further, content providers can value differentiating themselves from competitors based on respect for user privacy. In other words, a market for user information exists.

Here, the user agent component 110 can aid a user interacting with respect to a user information market in various manners. For instance, the user agent component 110 can receive, retrieve, or otherwise obtain or acquire offers for user information from one or more content providers by way of content provider components 130, for example, and evaluate the offers. By way of example, and not limitation, a content provider component 130 corresponding to a merchant website, for instance, can offer a discount, such as a five-dollar off coupon, in exchange for top-level, or coarse, user information. Where one or more offers are deemed acceptable, the user agent component 110 can subsequently transmit information to, and receive compensation from, corresponding content provider components 130 or other associated components. Moreover, in accordance with one embodiment, user permission or consent may be required prior to distributing user information to enable the user to control what information is distributed and to whom.

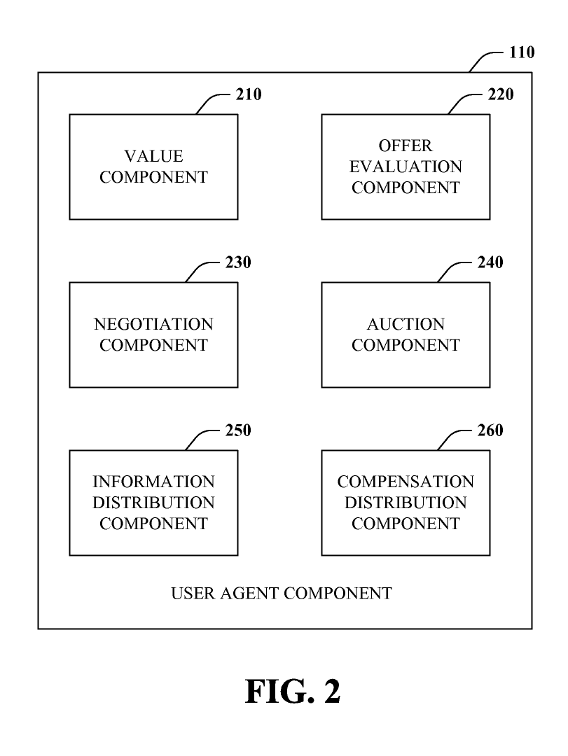

FIG. 2 illustrates an exemplary user agent component 110 in further detail. As previously mentioned, the user agent component 110 can aid a user in interaction with content providers, or others. Most users are unaware of the value of their information. Accordingly, the user agent component 110 includes value component 210 configured to estimate and provide the value of particular user information. Such an estimate can be determined as a function of current and previous offers, among other market factors. Further, value can vary based on the level of granularity of information, for instance, wherein specific information is more valuable that general information. For example, knowing that a user is interested in sports may be worth one dollar, water sports two dollars, and swimming five dollars. Users can employ value estimates to aid market interaction, for instance in determining whether to accept particular offers for information acquisition.

Offer evaluation component 220 can be configured to evaluate offers, for example as a function of user interest, desirability for personalization, desirability of privacy, interest value, and/and or offered compensation, among other factors. Based on evaluation, a recommendation can be made to a user regarding offers that should be considered for acceptance. For example, if an offer provides a monetary incentive greater than the value of requested information to be used for personalization of a website the user visits frequently, the offer can be recommended to the user for acceptance. Of course, the offer evaluation component 220 can function substantially automatically and request user permission to accept offers and distribute information.

Negotiation component 230 can be configured to assist a user in negotiating information release with respect to one or more requesting entities. In the previous example, where an offer is recommended the user can employ negotiation component 230 to provide a counter offer in an attempt to obtain a better deal. Further, the negotiation component 230 can enable interactions with content providers and selection of the best content provider as a function of various factors. By way of example, negotiations can occur with respect to multiple advertisement networks that offer advertisements to show to a user within a webpage. The negotiation can involve partially releasing information about a user to calibrate interest of the advertisement network in the particular individual and/or to increase the chances of an advertisement network bidding a higher amount.

The user agent component 110 can also solicit offers in various ways. In accordance with one embodiment, auction component 240 can be configured to set up and/or participate in an auction for user information. Parties can compete for a user's attention and information resulting in potentially higher compensation for the user than otherwise available. For example, various advertisers can vie for user information to facilitate target advertising wherein the highest bidder is the winner. If mechanisms exist that provide auction functionality, the auction component 240 can interact with such mechanisms. Alternatively, the auction component 240 can provide such mechanisms including establishing and enforcing auction rules, accepting bids, and/or determining a winning bid, among other things.

Upon accepting an offer, the user agent component 110 can include mechanisms to enable an exchange. Information distribution component 250 can acquire particular user information from a secure store and distribute to a content provider. Compensation distribution component 260 can acquire one or more forms of compensation from the content provider or related entity and distribute the compensation in accordance with an agreement with a user. For example, at least a portion of the compensation can be provided to the user. In one instance, a portion of the compensation can be designated as a fee or commission for orchestrating a transaction such as ten percent of the compensation.

The user agent component 110 generally manages distribution of user information to various entities including content providers and other users. Distribution can take substantially any form. For instance, user information can be directly sold to individual entities or consortiums. By way of example, a federated scheme can be utilized where a group of entities, such as a group of merchants, establishes a relationship with a user. In this manner, a user can agree to share information with a set of merchants so that the user does not have to interact with each merchant separately. In a more specific example, a user can agree to share user information with servers hosting websites for several clothing companies including the user's clothing sizes, gender, etc. That way, the user need not be prompted for such information every time the user visits another store.

The user agent component 110 can also be deployed in various locations. By way of example, the user agent component 110 can form part of a web browser. Alternatively, the user agent component 110 can be deployed on a network. For instance, the user agent component 110 can be embodied within a firewall that watches users browsing activity. This scheme can enable various differential privacy schemes. In yet another instance, the user agent component 110 can be deployed on a computer, where information mining is performed based on behavior with respect to the entire computer rather than a portion thereof such as a web browser.

What follows is a description of an exemplary system for acquiring user information that can be employed by the user agent component 110. The exemplary system is privacy-conscious which integrates well with the system 100. However, aspects described above as well as below with respect to brokering transactions are not limited to use with the below exemplary system.

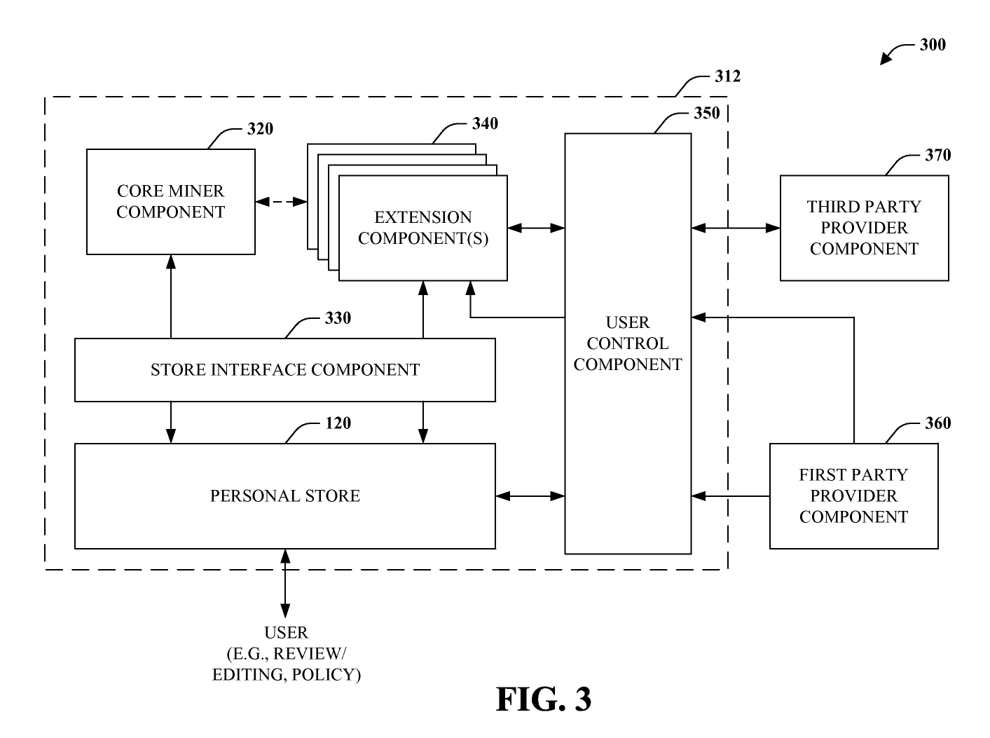

Referring initially to FIG. 3, a system 300 is illustrated that facilitates personalization in a privacy-conscious manner by collecting and managing user data securely. Herein, personalization is intended to refer at least to guiding a user towards information in which the user is likely to be interested and/or customizing layout or content to match a user's interests and/or preferences. By way of example and not limitation, personalization can include web site rewriting to rearrange or filter content, search engine result reordering, selecting a sub-subset of content to appear on an small display (e.g., mobile device), or targeted advertising. Of course, certain aspects of other types of personalization including memorizing information about a user to be replayed later and supporting a user's efforts to complete a particular task can also be supported. Moreover, personalization can be performed without sacrificing user privacy by making transfer of private user information, among other things, dependent upon user consent.

The system 300 can be employed at various levels of granularity with respect to a user's behavior, such as the user's interaction with digital content (e.g., text, images, audio, video . . . ). By way of example, and not limitation, interaction can be specified with respect to one or more computer systems or components thereof. To facilitate clarity and understanding, discussion herein will often focus on one particular implementation, namely a web browser. Of course, the claimed subject matter is not limited thereto as aspects described with respect to a web browser are applicable at other levels of granularity as well.

The system 300 includes personal store 120 that retains data and/or information with respect to a particular user. The data and/or information can be personal, or private, in terms of being specific to a particular user. While private data and/information can be highly sensitive or confidential information, such as financial information and healthcare records, as used herein the term is intended to broadly refer to any information about, concerning, or attributable to a particular user. The private data and/or information housed by the personal store 120 can be referred to as a user profile. Furthermore, the personal store 120 can reside local to a user, for example on a user's computer. As will be discussed further below, the private data/information can also reside at least in part on a network-assessable store (e.g., “cloud” storage.) As shown by the dashed box 312, the personal store 120 as well as other components can reside on a user's computer or component thereof such as a web browser. In other words, the components of 312 can correspond to a web browser component or system.

The private data can be received, retrieved, or otherwise obtained or acquired from a computer, component thereof, and/or third party content/service provider (e.g. web site). By way of example, data can be received or retrieved from a web browser including web browser history and favorites. Furthermore, such interaction with websites can include input provided thereto (e.g. search terms, form data, social network posts . . . ) as well as actions such as but not limited to temporal navigation behavior (e.g., hover-time of a cursor over particular data), clicks, or highlights, among other things.

Core miner component 320 is configured to apply a data-mining algorithm to discover private information. More specifically, the core miner component 320 can perform default (e.g., automatic, pervasive) user interest mining as a function of user behavior. In one embodiment, the behavior can correspond to web browsing behavior including visited web sites, history, and detailed interactions with web sites. Such data can be housed in the personal store 120, accessed by way of store interface component 330 (e.g., application programming interface (API)) (as well as a protocol described below), and mined to produce useful information for content personalization. By way of example and not limitation, the core miner component 320 can identify the “top-n” topics of interest and the level of interest in a given or returned set of topics. This can be accomplished by classifying individual web pages or documents viewed in the browser and keeping related aggregate information of total browsing history in the personal store 120.

In accordance with one embodiment, a hierarchical taxonomy of topics can be utilized to characterize user interest such as the Open Directory Project (ODP). The ODP classifies a portion of the web according to a hierarchical taxonomy with several thousand topics, with specificity increasing towards the leaf nodes of a corresponding tree. Of course, all levels of the taxonomy need not be utilized. For instance, if the first two levels of the taxonomy are utilized that can account for four-hundred and fifty topics. To convey the level of specificity, consider a root node that has science and sports child nodes, wherein the science node includes children such as physics and math and the sports node comprises football and baseball.

Various mining algorithms can be employed by the core miner component 320. By way of example and not limitation, a Naïve Bayes classification algorithm can be employed by the core miner component 320 for its well-known performance in document classification as well as its low computation cost on most problem instances. To create the Naïve Bayes classifier utilized by the core miner component 320, a plurality of documents (e.g., web sites) from each category in a predetermined number of levels of the ODP taxonomy can be obtained. Standard Naïve Bayes training can be performed on this corpus calculating probabilities for each attribute word for each class. Calculating document topic probabilities at runtime is then reduced to a simple log-likelihood ratio calculation over these probabilities. Accordingly, classification need not affect normal browser activities in a noticeable way.

To ensure that the cost of running topic classifiers on a document does not impinge on browsing activities, for example, the computation can be done on a background worker thread. When a document has finished parsing, its “TextContent” attribute can be queried and added to a task queue. When the background thread activates, it can consult this task queue for unfinished classification work, run topic classifiers, and update the personal store 120. Due to interactive characteristics of web browsing, that is, periods of burst activity followed by downtime for content consumption, there are likely to be many opportunities for the background thread to complete the needed tasks.

The classification information from individual documents can be utilized to relate information, including, in one instance, aggregate information, about user interests to relevant parties. For example, a “top-n” statistic can be provided, which reflects “n” taxonomy categories that comprise more of a user's browsing history, for example, than other categories. Computing this statistic can be done incrementally as browsing entries are classified and added to the personal store 120. In another example, user interest in a given set of interest categories can be provided. For each interest category, this can be interpreted as the portion of a user's browsing history comprised of sites classified with that category. This statistic can be computed efficiently by indexing a database underlying the personal store 120 on the column including the topic category, for instance.

One or more extension components 340 can also be employed. The core miner component 320 can be configured to provide general-purpose mining. The one or more extension components are configured to extend, or, in other words, supplement, the functionality of the core miner component 320 to enable near arbitrary programmatic interaction with a user's personal data in a privacy-preserving manner. Furthermore, in accordance with the supplemental aspect of the extension components 340 it is to be appreciated that the extension components 340 can optionally employ functionality provided by the system 100 such as the document classification of the core miner component 320. In accordance with an aspect of this disclosure, an extension component 340 can be configured to provide topic-specific functionality, web service relay (e.g., an application that relays private information between any number of web services using the personal store as a secure private conduit, thereby acting as a central point of storage for providing private information), or direct personalization, among other things.

Users may spend a disproportionate amount of time interacting with particular content, such as specific web sites, for instance (e.g., movie, science, finance . . . ). These users are likely to expect a more specific degree of personalization (topic/domain specific) on these sites than a general-purpose core mining can provide. To facilitate this, third-party authors can produce extensions that have specific understanding of user interaction with specific websites and are able to mediate stored user information accordingly. For example, a plugin could trace a user's interaction a website that provides online video streaming and video rental services, such as Netflix®, observe which movies the user likes and dislikes, and update the user's profile to reflect these preferences. Another example arises with search engines: An extension can be configured to interpret interactions with a search engine, perform analysis to determine interest categories the search queries related to, and update the user's profile accordingly.

A popular trend on the web is to open proprietary functionality to independent developers through application programming interfaces (APIs) over hypertext transfer protocol (HTTP). Many of these APIs have direct implications for personalization. For example, Netflix® has an API that allows a third-party developer to programmatically access information about a user's account, including movie preferences and purchase history. Other examples allow a third party to submit portions of a user's overall preference profile or history to receive content recommendations or hypothesized ratings (e.g., getglue.com, hunch.com, tastekid.com . . . ). An extension component 340 can be configured to act as an intermediary between a user's personal data and the services offered by these types of APIs. For instance, when a user navigates to a website to purchase movie tickets (e.g., fandango.com) the site can query an extension that in turn consults the user's online video rental interactions (e.g., Netflix®) and purchases (e.g., Amazon®), and returns derived information to the movie ticket website for personalized show times or film reviews.

In many cases, it is not reasonable to expect a website to keep up with a user's expectations when it comes to personalization. It may be simpler and more direct to employ an extension component that can access the personal store of user information, and modify the presentation of selected sites to implement a degree of personalization that the site is unwilling or unable to provide. To enable such functionality, an extension component 340 can interact with and modify the document object model (DOM) structure of selected websites to reflect the contents of the user's personal information. For example, an extension component can be activated once a user visits a particular website (e.g., nytimes.com) and reconfigure content layout (e.g., news stories) to reflect interest topics that are most prevalent in the personal store 120.

The store interface component 330 can enable one or more extension components 340 to access the personal store 120. Furthermore, the store interface component 330 can enforce various security policies or the like to ensure personal information is not misused or leaked by an extension component 340. User control component 350 can provide further protection.

The user control component 350 is configured to control access to private information based on user permission. First-party provider component 360 and third-party provider component 370 can seek to interact with the personal store 120 or add extension components 340 through the user control component 350 that can regulate interaction as a function of permission of a user. The first-party provider component 360 can be configured to provide data and/or an extension component 340. By way of example, the first-party provider component 360 can be embodied as an online video streaming and/or rental service web-browser plugin that tracks user interactions and provides data to the personal store 120 reflecting such interactions, as well as an extension component 340 to provision particular data and/or mined information derived from the data. The third-party provider component 370 can be a digital content/service provider that seeks user information for content personalization. Accordingly, a request for information can be submitted to the user control component 350, which in response can provide private information to the third-party provider component 370.

Regardless of provider, the user control component 350 can be configured to regulate access by requesting permission from a user with respect to particular actions. For example, with respect to the first-party provider component 360, permission can be requested to add data to the data store as well as to add an extension component 340. Similarly, a user can grant permission with respect to dissemination of private information to the third-party provider component 370 for personalization. In one embodiment, permission is granted explicitly for particular actions. For instance, a user can be prompted to approve or deny dissemination of specific information such as particular interests (e.g., science, technology, and outdoors) to the third-party provider. Additionally or alternatively, a user can grant permission to disseminate different information that reveals less about the user (e.g., biology interest rather than stem cell research interest). With respect to extension components 340, permission can be granted or denied based on capabilities, for example. As a result, the user can ensure that personal data is not leaked to third parties without explicit consent from the user and the integrity of the system is not compromised by extension components. To further aid security, permission can be transmitted in a secure manner (e.g., encrypted). In accordance with one embodiment, the user agent component 110 of FIGS. 1 and 2 can be incorporated with respect to the user control component 350 for example as a sub-component thereof or an independent component that interacts with the user control component 350.

To support a diverse set of extensions while maintaining control over sensitive information in the personal store 120, extension authors can express the capabilities of their code in a policy language. At the time of installation, users can be presented with the extension's list of requisite capabilities, and have the option of allowing or disallowing individual capabilities. Several policy predicates can refer to provenance labels, which can be <host, extensionid> pairs, wherein “host” is a content/service provider (e.g., web site) and “extensionid” is a unique identifier for a particular extension. Sensitive information used by extension components 340 can be tagged with a set of these labels, which allow policies to reason about information flows involving arbitrary <host, extensionid> pairs. A plurality of exemplary security predicates are provided in Appendix A. Additionally or alternatively, the policy governing what an extension is allowed to do can be verified by a centralized or distributed third party such as an extension gallery or a store, which will verify the extension code to make sure it complies with the policy and review the policy to avoid data misuse. Subsequently, the extension can be signed by the store, for example.

Given a list of policy predicates regarding a particular miner, the policy for that extension can be interpreted as the conjunction of each predicate in the list. This is equivalent to behavioral whitelisting: unless a behavior is implied by the predicate conjunction, the extension component 340 does not have permission to exhibit the behavior. Each extension component 340 can be associated with a security policy that is active throughout the lifespan of the extension.

Furthermore, when an extension component 340 requests information from the personal store 120, precautions can be taken to ensure that the returned information is not misused. Likewise, when an extension component 340 writes information to the personal store 120 that is derived from content on pages viewed by a user, for example, the system 300 can ensure user wishes are not violated. To enable such protection, functionality that returns information to the extension components 340 can encapsulate the information in a private data type “tracked,” which includes metadata indicating the provenance, or source of origin, of that information.

Such encapsulation allows the system 300 to take the provenance of data into account when used by the extension components 340. Additionally, “tracked” can be opaque—it does not allow extension code to directly reference the tracked data that it encapsulates without invoking a mechanism that seeks to prevent misuse. This means the system 300 can ensure non-interference to a degree mandated by an extension component's policy. By way of example and not limitation, whenever an extension component 340 would like to perform a computation over the encapsulated information, it can call a special “bind” function that takes a function-valued argument and returns a newly encapsulated result of applying it to the “tracked” value. This scheme prevents leakage of sensitive information, as long as the function passed to the “bind” does not cause any side effects. Verification of such property is described below.

Verifying the extension components 340 against their stated properties can be a static process. Consequently, costly runtime checks can be eliminated, and a security exemption will not interrupt a browsing session, for example. To meet this goal, untrusted miners (e.g., those written by third parties) can be written in a security-typed programming language, such as Fine, which enables capabilities to be enforced statically at compile time (e.g., by way of a secure type system that restricts code allowed to execute) as well as dynamically at runtime. As a result, programmers can express dependent types on function parameters and return values, which provides a basis for verification.

Functionality of the system 300 can be exposed to the extension components 340 through wrappers of API functions. The interface for these wrappers specifies dependent type refinements on key parameters that reflect the consequence of each API function on the relevant policy predicates. Two example interfaces are provided below:

```
val MakeRequest:
    p:provs ->
    {host:string | AllCanCommunicateXHR h p} ->
    t:tracked<string,p> ->
    {eprin:string | ExtensionId eprin} ->
    fp:{p:provs | forall (pr:prov).(InProvs pr p) <=>
                (InProvs pr p || pr = (P h eprin))} ->
    mut_capability ->
    tracked<xdoc,fp>
val AddEntry:
    ({p:provs | AllCanUpdateStore p}) ->
    tracked<string,p> ->
    string ->
    tracked<list<string>,p> ->
    mut_capability ->
    unit
```

The first example, “MakeRequest,” is an API used by extension components 340 to make HTTP requests; several policy interests are operative in this definition. The second argument of “MakeRequest” is a string that denotes a remote host with which to communicate, and is refined with the formula: “AllCanCommunicateXHR host p” where “p” is the provenance label of a buffer to be transmitted. This refinement ensures an extension component 340 cannot call “MakeRequest” unless its policy includes a “CanCommunicateXHR” predicate for each element in the provenance label “p.” The store interface component 330 can be limited, but assurances are provided that this is the only function that affects the “CanCommunicateXHR” predicate, giving a strong argument for correctness of implementation.

Notice as well that the third argument, and the return value, of “MakeRequest” are of the dependent type “tracked.” Such types are indexed both by the type of data that they encapsulate, as well as the provenance of that data. The third argument is the request string that will be sent to the host specified in the second argument; its provenance plays a part in the refinement on the host string discussed above. The return value has a provenance label that is refined in the fifth argument. The refinement specifies that the provenance of the return value of “MakeRequest” has all elements of the provenance associated with the request string, as well as a new provenance tag corresponding to “<host, eprin>,” where “eprin” is the unique identifier of the extension principle that invokes the API. The refinement on the fourth argument ensures that the extension passes its action “ExtensionId” to “MakeRequest.” These considerations ensure that the provenance of information passed to and from “MakeRequest” is available for policy considerations.

As discussed above, verifying correct enforcement of information flow properties can involve checking that functional arguments passed to “bind” are side effect free. Fortunately, a language such as Fine does not provide any default support for creating side effects, as it is purely functional and does not include facilities for interacting with an operating system. Therefore, opportunities for an extension component 340 to create a side effect are due to the store interface component 330. Thus, the task of verifying an extension is free of privacy and integrity violations (e.g., verification task) reduces to ensuring that APIs, which create side effects, are not called from code that is invoked by “bind,” as “bind” provides direct access to data encapsulated by “tracked” types.

“Affine” types are used to gain this property as follows. Each API function that may create a side effect takes an argument of “affine” type “mut_capability” (mutation capability), which indicates that the caller of the function has the right to create side effects. A value of type “mut_capability” can be passed to each extension component 340 to its “main” function, which the extension component 340 passes to each location that calls a side-effecting function. Because “mut_capability” is an affine type, and the functional argument of “bind” does not specify an affine type, the Fine type system will not allow any code passed to “bind” to reference a “mut_capability” value, and there is no possibility of creating a side effect in this code. As an example of this construct in the store interface component 330, observe that both API examples above create side effects, so their interface definitions specify arguments of type “mut_capability.”

The policy associated with an extension component 340 can be expressed within its source file, using a series of Fine “assume” statements: one “assume” for each conjunct in the overall policy. Given the type refinement APIs, verifying that an extension component 340 implements it stated policy is reduced to an instance of Fine type checking. The soundness of this technique rests on three assumptions:
The soundness of the Fine type system and the correctness of its implementation.
The correctness of the dependent type refinements placed on API functions. This amounts to less than one hundred lines of code, which reasons about a relatively simple logic of policy predicates. Furthermore, because the store interface component 330 is relatively simple, it is easy to argue that refinements are placed on all necessary arguments to ensure sound enforcement. In other words, the API usually only provides one function for producing a particular side effect, so it is not difficult to check that the appropriate refinements are placed at necessary points.
The correctness of the underlying implementation of API functions.

Further, the private information inferred or otherwise determined and housed in the personal store 120 can be made available a user. For instance, the information can be displayed to the user for review. Additionally, a user can optionally modify the information, for example where it is determined that the information is not accurate or is too revealing. Such functionality can be accomplished by way of direct interaction with the personal store 120, the user control component 350, and/or a second-party user interface component (not shown). Furthermore, a data retention policy can be implemented by the personal store 120 alone or in conjunction with other client components. For example, a user can specify a policy that all data about the user is to be erased after six months, which can then be effected with respect to the personal store 120.

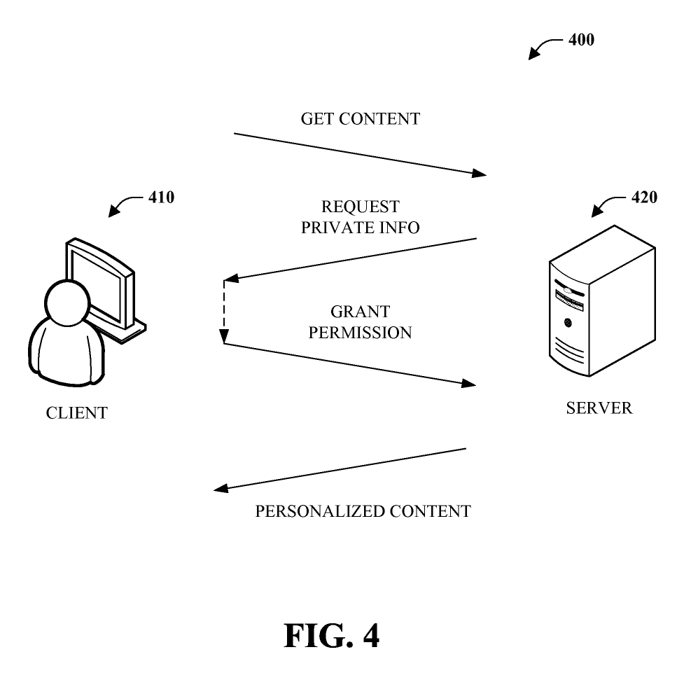

Turning attention to FIG. 4, an exemplary communication protocol 400 between client 410 and server 420 is depicted. The client 410 can correspond to a user computer and/or portion thereof, such as a web browser, and the server 420 can correspond to a remote digital content provider/service (e.g., website). Communication between the client 410 and the server 420 can be over a network utilizing hypertext transfer protocol (HTTP). As a result, the protocol 400 can be seamlessly integrated on top of existing web infrastructure.

The protocol 400 can address at least two separate issues, namely secure dissemination of user information and backward compatibility with existing protocols. In accordance with one embodiment, a user can have explicit control over the information that is passed from a browser to a third-party website, for example. Additionally, the user-driven declassification process can be intuitive and easy to understand. For example, when a user is prompted with a request for private information, it should be clear what information is at stake and what measures a user needs to take to either allow or disallow the dissemination. Finally, it is possible to communicate this information over a channel secure from eavesdropping, for example. With respect to backward compatibility, site operators need not run a separate background process. Rather, it is desirable to incorporate information made available by the subject system with minor changes to existing software.

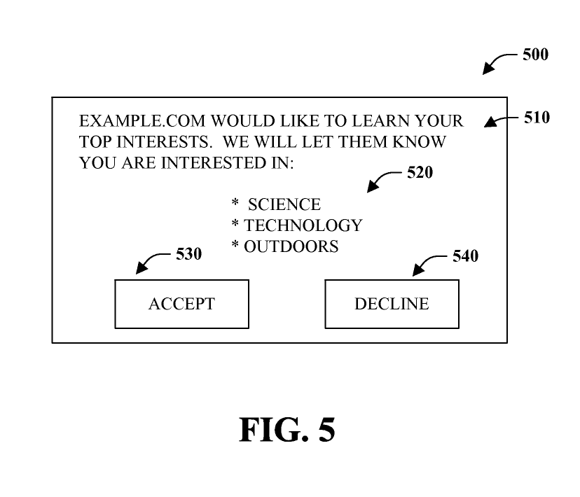

Broadly, the protocol 400 involves four separate communications. First, a request for content can be issued by the client 410 to the server 420. In response, the server 420 can request private information from the client. The request is then presented to a user via a dialog box or the like as shown FIG. 5.

Referring briefly to FIG. 5, dialog box 500 includes information identifying the requesting party as well as the type of information, here “example.com” and top interests. Further, the dialog box explicitly identifies the specific information 520 that satisfies the request and is proposed to send back to the requesting party (e.g., “science,” “technology,” and “outdoors”). The user can accept or decline the request by selecting a respective button, namely, accept button 530 and decline button 540.

Returning to FIG. 4, if permission is granted the requested and identified information can be returned to the server 420 in response to the request. Alternatively, returned is nothing, an indication that permission was denied and/or default non-personalized content. Where permission is granted, the server 420 can utilize any private information returned to personalize content returned in response to the initial request.

More specifically, the client 410 can signal its ability to provide private information by including an identifier or flag (e.g., repriv element) in the accept field of an HTTP header (typically employed to specify certain media types which are acceptable for the response) with an initial request (e.g. GET). If a server process (e.g., daemon) is programmed to understand this flag, the server 420 can respond with an HTTP 300 multiple-choices message providing the client 410 with the option of subsequently requesting default content or providing private information to receive personalized content. The information requested by the server 420 can be encoded as URL (Uniform Resource Locator) parameters in one of the content alternatives listed in this message. For example, the server 420 can request top interests or interest levels, which can be encoded as “top-n & level=n” or “interest=catN,” respectively, where “n” is the number of top interest levels and “N” is the number of interest categories. At this point, a browser on the client 410 can prompt the user regarding the server's information request in order to declassify the otherwise prohibited flow from the personal store 120 to an untrusted party. If the user agrees to the information release, the client 410 can respond with an HTTP “POST” message, or the like, to the originally requested document, which additionally includes the answer to the server's request. Otherwise, the connection can be dropped.

Various additions/extensions can be added to the protocol 400 to support additional functionality including user agent functionality. For example, additional transactions can pertain to negotiation of compensation for requested information.

Note that in accordance with one embodiment, expressive and explicit information regarding dissemination of private user information to remote parties, for example, is provided to a user who can manually permit or disallow dissemination. For core mining data, this is not particularly challenging. In fact the structure of information produced by the core miner component 320 of FIG. 3 can be designed to be highly informative to content providers and intuitive for end users. In particular, when prompted with a list of topics that will be communicated to a remote party, most users will understand the nature and degree of information sharing that will subsequently take place if they consent. However, there is danger of overwhelming the user with prompts for access control, effectively de-sensitizing the user to the problems addressed by the prompts. Accordingly, in another embodiment, the interactive burden can be reduced by remembering the user's response for a particular domain and automating consent. In yet another embodiment, a trusted policy “curator,” or the like, can maintain recommended dissemination settings for a set of popular web sites, for example. This is similar to an application store/curator model that can be employed with respect to maintaining and providing extensions.

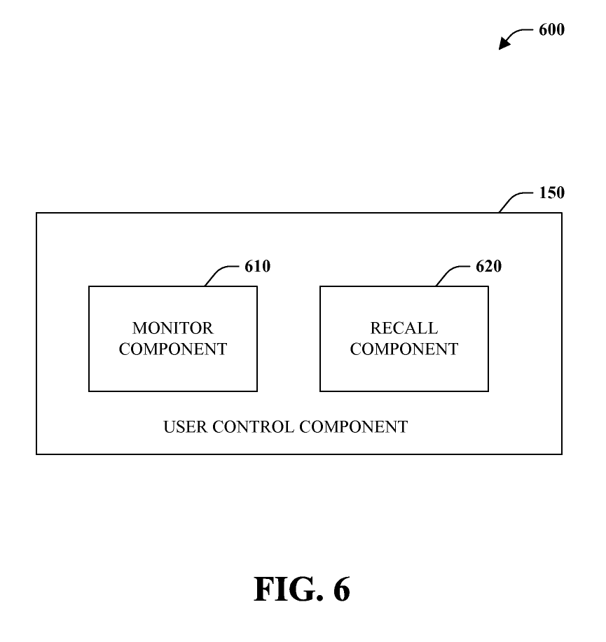

Referring to FIG. 6, a representative user-control component 350 is illustrated. The user control component 350 can include additional functionality relating to information dissemination and regulation thereof. As shown, the user control component 350 includes monitor component 610 and recall component 620. The monitor component 610 is configured to track dissemination of information provided by way of the user control component 350. Type and/or specific information as well as to whom the information was provided can be recorded. Based thereon, analysis can be performed and decisions can be made regarding disseminated information. By way of example and not limitation, a comparison can be performed between what information was authorized by a user and what data was actually provided to detect information leaks. Recall component 620 is configured to recall information previously provided. For instance, the recall component 620 can work in in conjunction with a process residing on a third-party content provider that enables exchange of information to order return of previously disseminated information. Such recall functionality can be employed to updated or correct inaccurate information, for example. Additionally or alternatively, information can be recalled if a third-party content provider violates terms of use to protect private user information after dissemination. Further, the recall functionality is particular useful where the implications of extension component policies are not well understood by a user even though the policies may be expressive and precise.

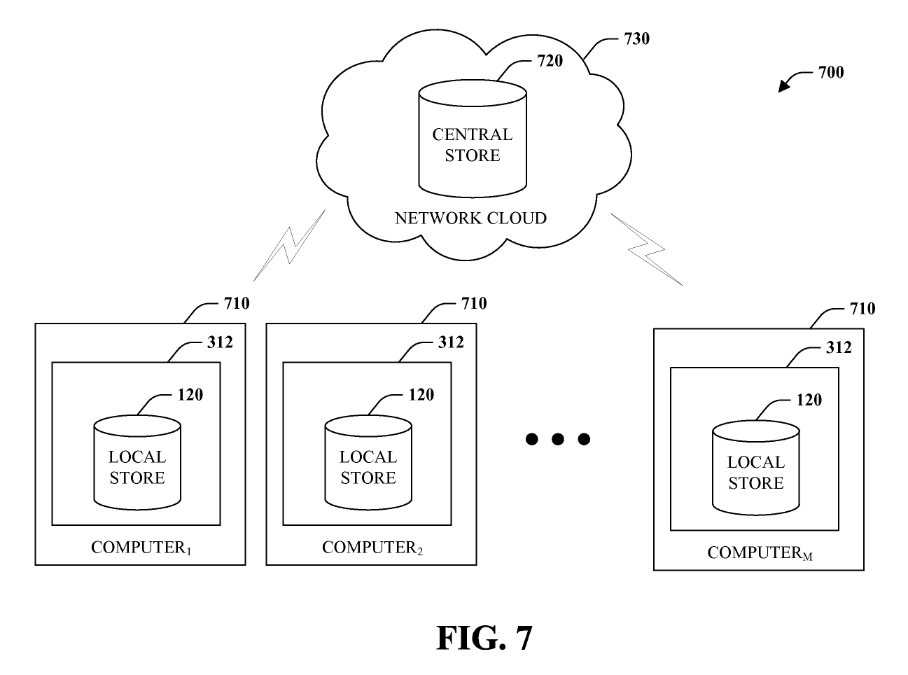

FIG. 7 illustrates a distributed system 700 within which aspects of the disclosure can be employed. Often users own and employ many computers or like processor-based devices (e.g., desktop, laptop, tablet, phone . . . ). Moreover, a user's behavior on a first computer may be quite different from behavior on a second computer. For example, a desktop and/or laptop can be employed for work-related utilization while a tablet is employed for personal use. The system 700 enables collection and dissemination of private information across such computers thus enabling highly pertinent content personalization to be provided.

As shown, the system 700 includes a plurality of user computers (COMPUTER₁−COMPUTER_{M}, where “M” is a positive integer greater than one). Each of the plurality of computers 710 can include a web browser 312 including a personal store or more specifically a local personal store 120, among other components previously described with respect to FIG. 3. Further, the computers 710 are communicatively coupled with a network-accessible central store 720 by way of network cloud 730, for instance. By way of example, the central store 720 can be accessible through a web service/application, or the like. In accordance with one embodiment, the central store 720 can be utilized to synchronize information across a number of local personal stores 120. Information collected across multiple computers such as a desktop, laptop, and tablet can be employed to obtain a more holistic view of a user than enabled by each computer independently, and, as a result, provision highly relevant content personalization. Of course, users may also dictate source aggregation to maintain distinct identities (e.g., work, home . . . ). This can be enabled by, among other things, providing a mechanism to accept an identity and perform data collection with respect to that particular identity and/or segmentation of computers for independent identities (e.g., desktop->work, tablet->personal).

Various personalization scenarios are enabled by the system 300 of FIG. 3 and components thereof, wherein users are provided precise control over information about them that is released to remote parties. More specifically, described functionality can be employed with respect to content targeting as well as target advertising.

Commonplace on many online merchant websites is content targeting: The inference and strategic placement of content likely to compel a user, based on previous behavior. Although a few popular websites already support this functionality without issue (e.g., amazon.com, netflix.com), the amount of personal information collected and maintained by such sites have real implications for personal privacy that may surprise many users. Additionally, the fact that the personal data needed to implement this functionality is vaulted on a particular site is an inconvenience for the user, who would like to use their personal information to receive better experience on a competitor's site. By keeping information local to the user in a web browser, for example, both problems are solved.

As a concrete example, consider that news sites should be able to target specific stories to users based on their interests. This could be done in a hierarchical fashion, with various degrees of specificity. For instance, when a user navigates to “nytimes.com,” the main site could present the user with easy access to relevant types of stories (e.g., technology, politics . . . ). When the user navigates to more specific portions of the site, for instance looking solely at articles related to technology, the site could query for specific interest levels on sub-topics, to prioritize stories that best match the user. As the site attempts to provide this functionality, a user should be able to decline requests for personal information, and possibly offer related personal information that is not as specific or personally identifying as a more private alternative. Notice that “nytimes.com” does not play a special role in this process. Immediately after visiting “nytimes.com,” a competing site such as “reuters.com” could utilize the same information about the user to provide a similar personalized experience.

Advertising serves as one of the primary enablers of free content on web, and targeting advertising allows merchants to maximize the efficiency of their efforts. The system 300 can facilitate this task in a direct manner by allowing advertisers to consult a user's personal information, without removing consent from the picture. Advertisers have incentive to user the accurate data stored by the subject system 300, rather than collecting their own data, as the information afforded by the system 300 is more representative of a user's overall behavior. Additionally, consumers are likely to select businesses who engage in practices that do to seem invasive.

Most conventional targeted advertising schemes today make use of an interest taxonomy that characterizes market segments in which a user is most likely to show interest. Consequently, for the subject system to facilitate existing targeted advertising schemes, the system can allow a third party to infer this type of information with explicit consent from a user.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems above and methods below can include artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the core miner component 320 as well as extension components 340 can employ such mechanisms to infer user interests, for instance. Further, the user agent component 110 can employ the mechanisms to aid value estimation and negotiation, among other things.

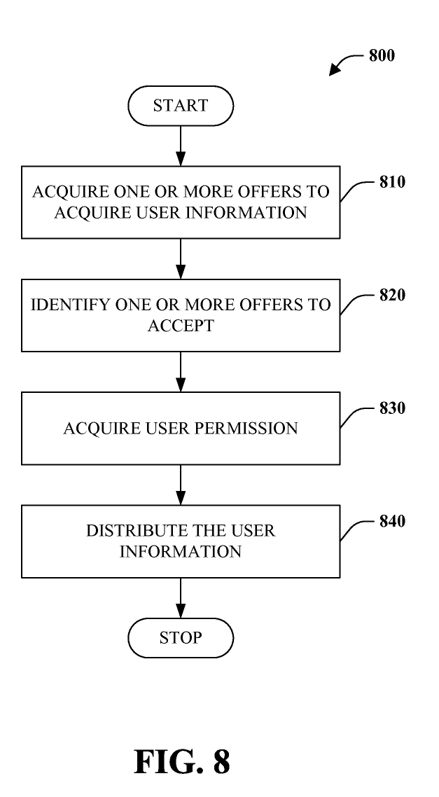

In view of the exemplary systems described supra, methodologies that may be implemented in accordance with the disclosed subject matter will be better appreciated with reference to the flow charts of FIGS. 8-14. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Referring to FIG. 8, a method 800 of managing distribution of user information is illustrated. At reference numeral 810, one or more offers to acquire user information are acquired. At numeral 820, one or more offers are identified for acceptance. For example, the offers can be identified based on compensation, information requested, and/or user preferences regarding goals and privacy, among other things. At reference 830, user information is acquired with respect to the one or more identified offers. At reference numeral 840, user information can be distributed as a function of user permission. In other words, identified offers can be accepted and subsequently processed upon receipt of user consent.

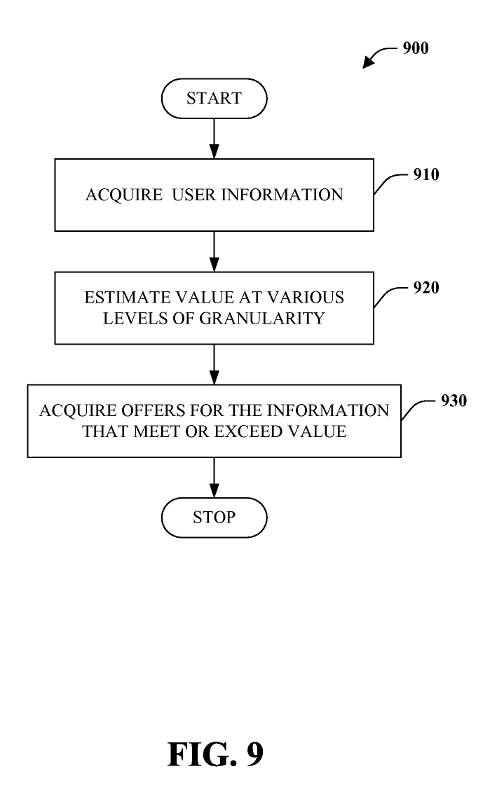

FIG. 9 depicts a method 900 of offer acquisition. At numeral 910, user information is acquired, for example from a secure personal store. At numeral 920, values are estimated for the user information at various levels of granularity. For example, specific information can be more valuable than general information such that “swimming” is more valuable than “sports.” Values can be estimated based on current, past, and/or predicted market conditions including offered compensation. At reference numeral 930, offers can be acquired for information that meet or exceed the estimated value thereof for further evaluation and potential acceptance.

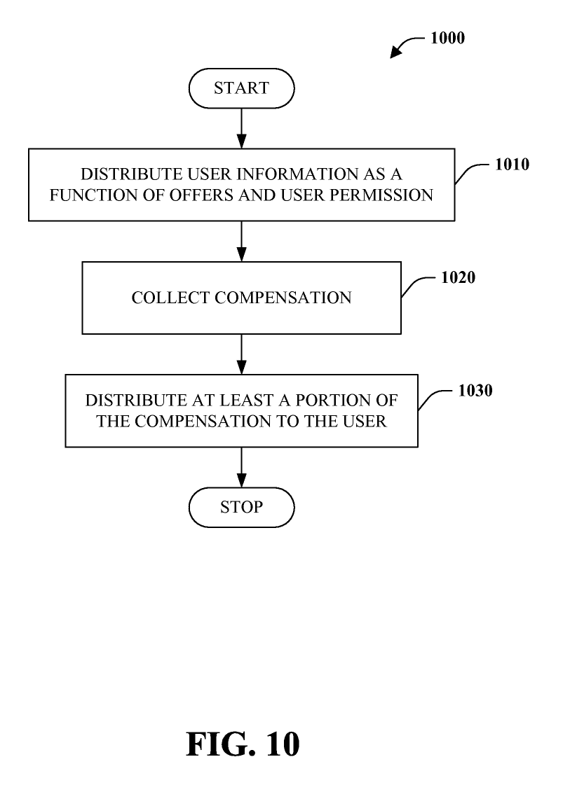

FIG. 10 is a flow chart diagram of a method 1000 of brokering user information agreements. At reference numeral 1010, user information is distributed as a function of one or more offers and user permission. Stated differently, user information can be distributed for one or more offers to acquire information accepted with user consent. At numeral 1020, compensation associated with one or more offers is collected. Such compensation can be money, discount codes/coupons, and/or reward points, among others. At reference numeral 1030, at least a portion of the collected compensation is distributed to a user. An undistributed portion of the collected compensation can correspond to a fee and/or commission (e.g., 10%) for orchestrating a transaction.

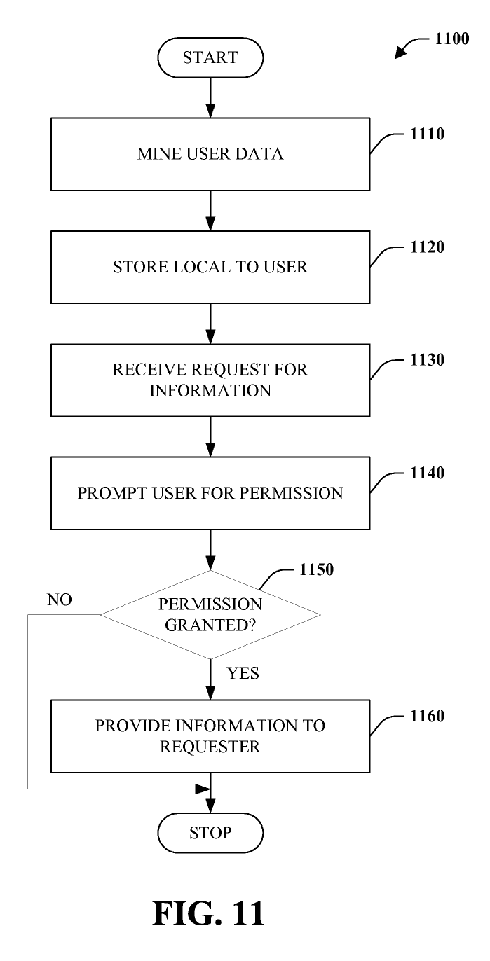

Referring to FIG. 11, a method 1100 is illustrated that facilitates personalization in a privacy conscious manner. At reference numeral 1110, user data is mined More specifically, data regarding user behavior, collected based on browser activity, for example, can be employed to infer or determine valuable user information such as interests. The data mining or like analysis can be performed by a default core miner general in nature and/or an extension component that provides more domain-, or topic-, specific information. At numeral 1120, data and/or determined information can be stored local to a user, for example on a particular user machine or component thereof (e.g., web browser). Local storage is advantageous in that such storage facilitates control of user personal information. At reference 1130, a request is received or otherwise acquired for information such as user interests. For example, a digital content/service provider can request such information to enable personalization. At numeral 1140, a user is prompted for permission to provide the requested information. For example, a dialog box or the like can be spawned that identifies the requester and requested information and provides a mechanism for granting or denying permission. A determination is made at reference numeral 1150 as to whether permission was granted by the user. Note that a user can provide permission to reveal the requested information or alternate information that may be less revealing and more acceptable to a user (e.g., science interest rather than interest in stem cell research). If permission is granted for the information as requested or an alternate form thereof, such information can be provided to the requester at numeral 1160. Alternatively, if permission is denied (not granted) the method 1100 can terminate without revealing any user information. As a result, the information requesting provider can return default non-personalized content.

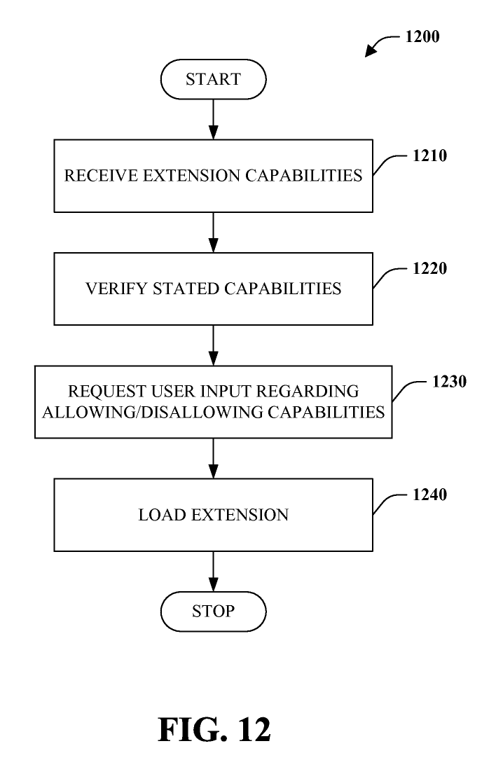

FIG. 12 depicts a method 1200 of extending system functionality. At reference numeral 1210, an extension's capabilities are received, retrieved, or otherwise obtained or acquired. For example, the extensions capabilities can be explicitly specified in a security-typed programming language, such as Fine. At numeral 1220, the stated capabilities are verified. Such verification can be performed, manually, automatically, or semi-automatically (e.g., user directed). Upon verification of stated capabilities, a request can be provided to a user regarding employment of the particular extension as well as capabilities thereof at numeral 1230. For example, a user can indicate that the extension can load as is thereby accepting capabilities of the extension. Alternatively, the user can indicate that a subset of capabilities are allowed or disallowed. If permitted by the user, the extension can be loaded, at 1240, with all or a subset of capabilities, where enabled.

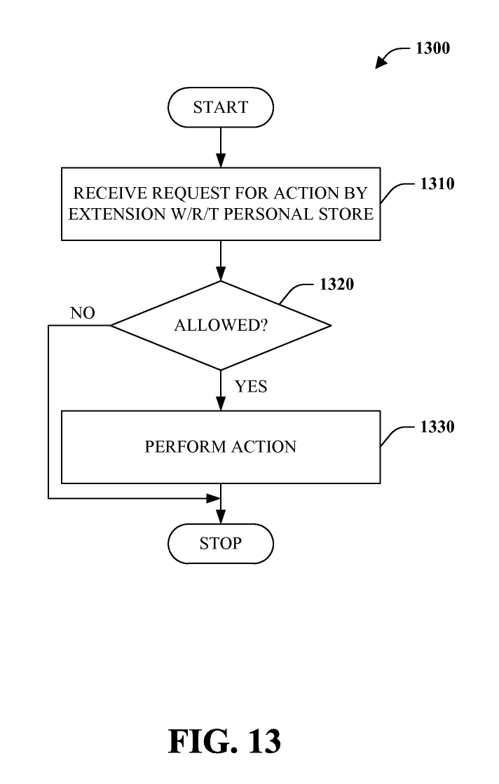

FIG. 13 is a flow chart diagram of a method 1300 of secure extension operation. At reference numeral 1310, a request is received, retrieved, or otherwise acquired for action by an extension with respect to a personal store. For example, system extension can seek to read, write, or modify the personal store. At reference 1320, a determination is made as to whether a requested action is allowed based on a security policy or the like associated with the extension and capabilities and thereof. If disallowed at 1320 (“NO”), the method terminates without performing the action and optionally notifying the extension as to why. Alternatively, if the action is allowed at 1320 (“YES”), the action is performed at reference numeral 1330. Note that information can be tagged with metadata identifying the entity responsible for information in the personal store including the associated extension, thereby enabling reasoning about information flow. Furthermore, information can be encapsulated in a private type that does not permit extension code to directly access the information without invoking one or more mechanisms that prevents misuse.

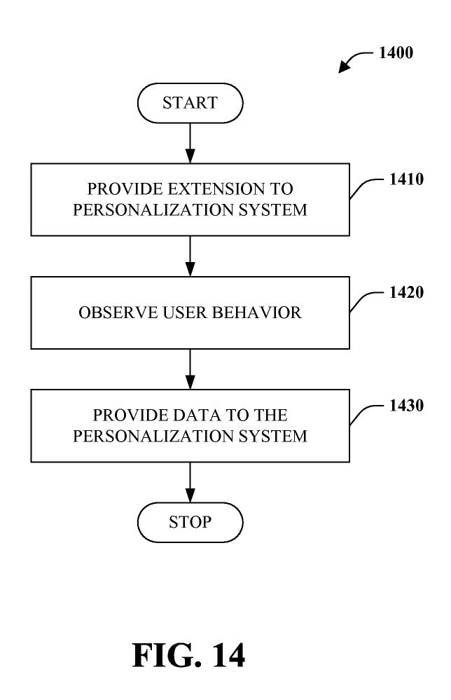

FIG. 14 depicts a method 1400 of interacting with a system that facilitates personalization in a privacy-conscious manner (or simply personalization system). At reference numeral 1410, a third-party content provider can provide an extension component to the personalization system to supplement existing functionality, for example by providing topic specific data mining. At numeral 1420, the third-party content provider can observe user behavior with respect to interaction with content. For example, interaction can pertain to navigation to content, purchases, recommendations, among other things. At reference numeral 1430, data regarding user behavior is provided to the personalization system. Subsequently, the extension component can be employed to perform actions utilizing the provided data.

What follows is a description of a few examples of extension components 340 that can be utilized by the system 300. Of course, the below examples are not meant to limit the claimed subject manner in any way but rather are provided to further aid clarity and understanding with respect to an aspect of the disclosure.

A search engine extension component can be employed that understands the semantics of a particular website (e.g., search site), and is able to update the personal store accordingly. The functionality of such an extension component is straightforward: When a user navigates to the site hosted by a search provider, the extension component receives a callback from the browser, at which point it attaches a listener on “submit” events for a search form. Whenever a user sends a search query, the callback method receives the contents of the query. A default document classifier afforded by the system can subsequently be invoked to determine which categories the query may apply to, and updates the personal store accordingly.

To carry out these tasks the search engine extension component can specific capabilities including, for example:
Listen for document object model (DOM) “submit” events on web sites provided by the search provider.
Read parts of the DOM of sites hosted by the search provider so that it can locate the query form.
Write data to the personal store.

A micro-blogging extension can be similar to the search engine extension. More specifically, a user's interactions one a website are explicitly intercepted, analyzed, and used to update the user's interest profile. However, unlike the search engine extension, the micro-blogging extension of Twitter®, for example, does not need to understand the structure of webpages or the user's interaction with them. Rather, it can utilize an exposed representational state transfer API to periodically check a user's profile for updates. When there is a new post, the extension component can utilize a document classifier to determine how to update the personal store. To perform these tasks the micro-blogging extension can require capabilities such as:
Send requests to a micro-blogging website.
Write to the personal store.

An extension component associated with an online video rental service extension such s Netflix® can be slightly more complicated than the first two exemplary extension components. This extension component can perform two high-level tasks. First, it observers user behavior on a particular web site associated with the service and updates the personal store to reflect the user's interactions with the site. Second, the extension component can provide specific parties (e.g., fandango.com, amazon.com, metacritic.com . . . ) with a list of the user's most recently views movies for a specific genre. To enable such functionality, this extension component can require capabilities such as:
Listen for click events on DOM elements with particular class labels indicative of the rating a user gives to a movie.
Update the personal store to reflect derived information as well as read that information at a later time.
Return information read from the personal store to requests by specific websites.
Read from a local file to associate movies in the personal store with genre labels given in requests from third parties.
   Note that the policy is explicit about information flows. In particular, data computed by the extension component can be communicated to a small number of third-party sites. This degree of restrictiveness can ensure the privacy of the user's information without obligating the user to respond to multiple access control checks at runtime.

An extension component that pertains to providing information concerning content consumed, such GetGlue®, can be different from previous examples in that it need not add anything to the personal store. Rather, this extension component provides a conduit between third-party websites that want to provide personalized content, the user's personal store information, and another third party (e.g., getglue.com) that uses personal information to provide intelligent content recommendations. A function that effectively multiplexes the user's personal store to “getglue.com” can be provided by the extension component, wherein a third-party site can use the function to query “getglue.com” using data in the personal store. This communication can be mode explicit to the user in the policy expressed by the extension component. Given the broad range of topics such service is knowledgeable about it makes sense to open this functionality to pages from many domains. This creates novel policy issues. For example, a user may not want information in the personal store collected from by a first content provider (e.g., netflix.com) to be queried on behalf of a second content provider (e.g., linkedin.com), but may still agree to allow the second content provider (e.g., linkedin.com) to use information collected from a third content provider (e.g., twitter.com, facebook.com . . . ). Likewise, the user may want certain sites (e.g., amazon.com, fandgo.com . . . ) to use the extension to as “getglue.com” for recommendations based on the data collected from “netflix.com.” This determination can also be made by a third party tasked with verifying or validating extensions, independently of the user.

The usage scenario suggests a more complex policy in terms of capabilities, such as:
Communicate personal store information from a first set of content providers (e.g., twitter.com, facebook.com) to a second set of content providers (e.g., linkedin.com) as well as send information tagged with the label from “getglue.com,” for example.
Transmit information from a first content provider (e.g. netflix.com) to “getglue.com” on behalf of a second content provider (e.g., amazon.com, fandango.com . . . ).
   The policy requirements of such an extension component can be made possible by support for multi-label provenance tracking as previously described. Note also that the assumption that “getglue.com” is not a malicious party, and does not otherwise pose a threat to the privacy concerns of the user. This judgment can be left to the user, as the personalization system makes explicit the requirement to communicate with this party and guarantees that a leak will not occur to any other party.

As used herein, the terms “component,” “system,” “engine,” as well as forms thereof (e.g., components, sub-components, systems, sub-systems . . . ) are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers. The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner. It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

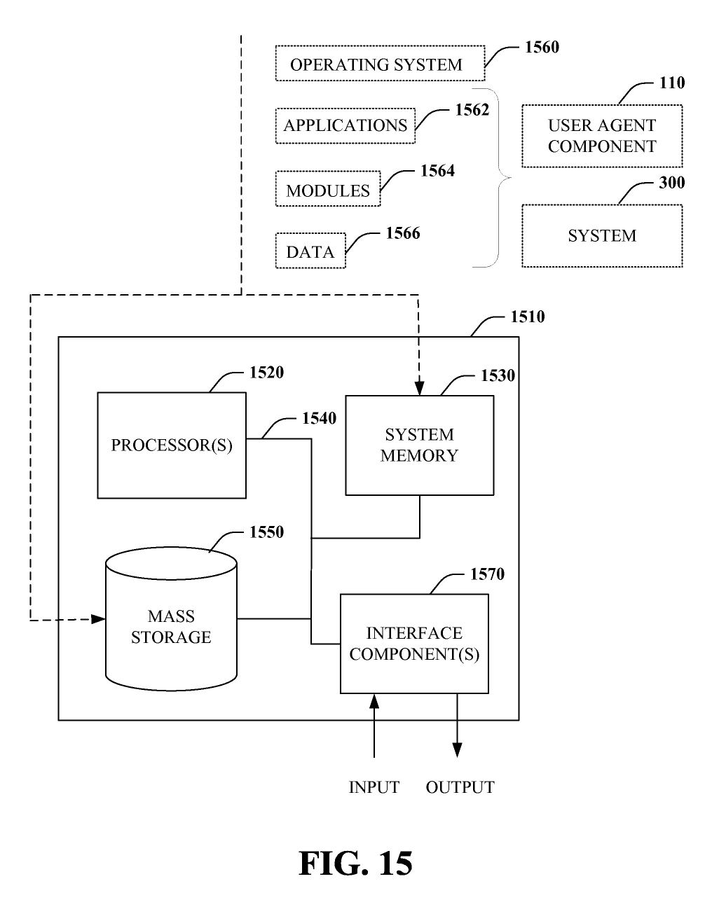

In order to provide a context for the claimed subject matter, FIG. 15 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 15, illustrated is an example general-purpose computer 1510, or computing device, (e.g., desktop, laptop, server, hand-held, programmable consumer or industrial electronics, set-top box, game system . . . ). The computer 1510 includes one or more processor(s) 1520, memory 1530, system bus 1540, mass storage 1550, and one or more interface components 1570. The system bus 1540 communicatively couples at least the above system components. However, it is to be appreciated that in its simplest form the computer 1510 can include one or more processors 1520 coupled to memory 1530 that execute various computer executable actions, instructions, and or components stored in memory 1530.

The processor(s) 1520 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 1520 may also be implemented as a combination of computing devices, for example a combination of a DSP and a microprocessor, a plurality of microprocessors, multi-core processors, one or more microprocessors in conjunction with a DSP core, or any other such configuration.

The computer 1510 can include or otherwise interact with a variety of computer-readable media to facilitate control of the computer 1510 to implement one or more aspects of the claimed subject matter. The computer-readable media can be any available media that can be accessed by the computer 1510 and includes volatile and nonvolatile media, and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 1510.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 1530 and mass storage 1550 are examples of computer-readable storage media. Depending on the exact configuration and type of computing device, memory 1530 may be volatile (e.g., RAM), non-volatile (e.g., ROM, flash memory . . . ) or some combination of the two. By way of example, the basic input/output system (BIOS), including basic routines to transfer information between elements within the computer 1510, such as during start-up, can be stored in nonvolatile memory, while volatile memory can act as external cache memory to facilitate processing by the processor(s) 1520, among other things.

Mass storage 1550 includes removable/non-removable, volatile/non-volatile computer storage media for storage of large amounts of data relative to the memory 1530. For example, mass storage 1550 includes, but is not limited to, one or more devices such as a magnetic or optical disk drive, floppy disk drive, flash memory, solid-state drive, or memory stick.

Memory 1530 and mass storage 1550 can include, or have stored therein, operating system 1560, one or more applications 1562, one or more program modules 1564, and data 1566. The operating system 1560 acts to control and allocate resources of the computer 1510. Applications 1562 include one or both of system and application software and can exploit management of resources by the operating system 1560 through program modules 1564 and data 1566 stored in memory 1530 and/or mass storage 1550 to perform one or more actions. Accordingly, applications 1562 can turn a general-purpose computer 1510 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example, and not limitation, the user agent component 110 and/or system 300, or portions thereof, can be, or form part, of an application 1562, and include one or more modules 1564 and data 1566 stored in memory and/or mass storage 1550 whose functionality can be realized when executed by one or more processor(s) 1520.

In accordance with one particular embodiment, the processor(s) 1520 can correspond to a system on a chip (SOC) or like architecture including, or in other words integrating, both hardware and software on a single integrated circuit substrate. Here, the processor(s) 1520 can include one or more processors as well as memory at least similar to processor(s) 1520 and memory 1530, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the user agent component 110 and/or system 300 and/or associated functionality can be embedded within hardware in a SOC architecture.

The computer 1510 also includes one or more interface components 1570 that are communicatively coupled to the system bus 1540 and facilitate interaction with the computer 1510. By way of example, the interface component 1570 can be a port (e.g., serial, parallel, PCMCIA, USB, FireWire . . . ) or an interface card (e.g., sound, video . . . ) or the like. In one example implementation, the interface component 1570 can be embodied as a user input/output interface to enable a user to enter commands and information into the computer 1510 through one or more input devices (e.g., pointing device such as a mouse, trackball, stylus, touch pad, keyboard, microphone, joystick, game pad, satellite dish, scanner, camera, other computer . . . ). In another example implementation, the interface component 1570 can be embodied as an output peripheral interface to supply output to displays (e.g., CRT, LCD, plasma . . . ), speakers, printers, and/or other computers, among other things. Still further yet, the interface component 1570 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating personalization, comprising:
employing at least one processor configured to execute computer-executable instructions stored in memory to perform the following acts:
managing distribution of user information as a function of one or more offers to acquire the information and user permission.

2. The method of claim 1 further comprises distributing the information to a consortium.

3. The method of claim 1 further comprises distributing the information at a particular level of granularity.

4. The method of claim 1 further comprises distributing the information to a seller of goods and/or services as a function of a discount for purchase of the goods and/or services.

5. The method of claim 1 further comprises distributing the information as a function of reward program points.

6. The method of claim 1 further comprises interacting with multiple parties among which one or more is selected by way of an auction.

7. The method of claim 1 further comprises estimating value of the information.

8. The method of claim 7, estimating the value based on different levels of granularity.

9. The method of claim 1 further comprises negotiating compensation for distributing the information.

10. The method of claim 9 further comprises distributing a portion of the information prior to or as part of the negotiating act.

11. A system that facilitates content personalization, comprising:
a processor coupled to a memory, the processor configured to execute the following computer-executable components stored in the memory:
a first component configured to manage distribution of information about user preferences as a function of one or more offers to acquire the information and user consent.

12. The system of claim 11, at least one of the one or more offers includes a discount on purchase of goods and/or services.

13. The system of claim 11, at least one of the one or more offers includes points in a reward program.

14. The system of claim 11 further comprises a second component configured to estimate value of the information.

15. The system of claim 11 further comprises a second component configured to facilitate negotiation of compensation for the information.

16. The system of claim 11, the first component is part of a web browser.

17. The system of claim 11, the first component is part of a network communication component.

18. A computer-readable storage medium having instructions stored thereon that enables at least one processor to perform the following acts:
managing distribution of user interest information inferred from web browser interaction as a function of user permission and offers to acquire the information.

19. The computer-readable storage medium of claim 18 further comprising estimating value of the user interest information.

20. The computer-readable storage medium of claim 18 further comprising auctioning the user interest information.
